(19) United States
(12) Patent Application Publication
(10) Pub. No.: US 2012/0168382 A1
(43) Pub. Date: Jul. 5, 2012

(54) Enhanced Clarification Media

(75) Inventors: KS Cheng, Nashua, NH (US); Senthil Ramaswamy, Nashua, NH (US); Brian Gagnon, Billerica, MA (US); Maybelle Woo, Braintree, MA (US); Mikhail Kozlov, Belmont, MA (US)

(73) Assignee: EMD MILLIPORE CORPORATION, Billerica, MA (US)

(21) Appl. No.: 13/414,747

(22) Filed: Mar. 8, 2012

Related U.S. Application Data
(62) Division of application No. 13/102,081, filed on May 6, 2011.
(60) Provisional application No. 61/332,350, filed on May 7, 2010.

(51) Int. Cl. B01D 15/00

(52) U.S. Cl. 210/663

(57) ABSTRACT

Media and devices, such as nitrocellulose-based filters, wherein the media is coated with a polymer such as a polyallylamine. The resulting device offers strong binding of protein impurities and superior removal of host cell proteins from biological samples.

This application is a divisional of U.S. patent application Ser. No. 13/102,081 filed May 6, 2011, which claims priority of U.S. Provisional Application Ser. No. 61/332,350 filed May 7, 2010, the disclosures of which are incorporated herein by reference.

### BACKGROUND

The embodiments disclosed herein is relate to membranes having coated cross-linked polyallylamine.

Prefiltration media such as Millipore's commercial mixed cellulose ester based RW prefilters are extensively used to filter cell-culture feeds post centrifugation or primary clarification. The RW filters are microporous air-cast membranes supported by an embedded non-woven. These filters are available in a multitude of pore-sizes and can be produced fairly inexpensively with increased thickness compared to other microporous membranes. They also have a very uniform pore-size distribution when compared to standard non-woven materials. As such, these filters are ideal for membrane chromatography applications where a large volume of functionalized symmetric membrane is desirable.

The RW prefilters comprise a uniform symmetric mixed cellulose ester membrane structure supported by a non-woven material which acts as an ideal substrate for membrane chromatography. Such membranes are particularly effective in applications requiring high flow rates and large volume filtration such as clarification of solutions.

It would be desirable to utilize such membranes to provide low-cost uniform membrane adsorbers, particularly in applications requiring large volumes, such as in the clarification of cell culture media with high loads of impurity and high conductivities.

### SUMMARY

The problems of the prior art have been overcome by the embodiments disclosed herein, which provide media having a coating comprising a polymer such as a polyallylamine, and methods of purifying biological samples using such media. In certain embodiments, the media comprises a mixed cellulose ester membrane supported on a substrate, such as a nitrocellulose/cellulose acetate membrane on a polyester substrate. The polyallylamine gel can significantly improve the capacity of the filter for certain species such as HCP and DNA, thus providing a benefit for the clarification or purification of biological feedstocks. The result is a low-cost uniform membrane adsorber, exhibiting low pressure drop, that enables the utilization of such adsorbers in applications requiring large volumes, such as clarification of cell culture media with high loads of impurity and high conductivities.

In certain embodiments, a method is disclosed to significantly increase the sorptive capacity of nitrocellulose based filters by coating or otherwise incorporating in the filter material a loosely cross-linked hydrogel. The resulting filters remove certain species such as host cell proteins (HCPs) from biological samples such as solutions of monoclonal antibodies (MABs). Polymeric primary amines, preferably aliphatic polymers having a primary amine covalently attached to the polymer backbone, more preferably having a primary amine covalently attached to the polymer backbone by at least one aliphatic group, preferably a methylene group, bind negatively charged species such as impurities exceptionally strongly and thus are the preferred class of materials for creating the adsorptive hydrogel.

### BRIEF DESCRIPTION OF THE DRAWINGS

FIG. 1 is a graph of host cell protein concentration vs. column volume; and

FIG. 2 is a graph of DNA concentration vs. column volume.

### DETAILED DESCRIPTION OF SPECIFIC EMBODIMENTS

The embodiments disclosed herein relate to filter media, particularly nitrocellulose-based prefilters coated with a porous, polymeric coating. The filters are particularly suited for prefiltration, such as prefiltration of cell-culture feeds for removal of impurities to reduce excessive loads on downstream purification processes. Typical impurities include DNA, endotoxin, HCP and viruses. The media functions well at high salt concentration and high conductivity (high affinity), effectively removing impurities even under such conditions. High binding capacity without sacrificing device permeability is achieved.

Absorption refers to taking up of matter by permeation into the body of an absorptive material. Adsorption refers to movement of molecules from a bulk phase onto the surface of an adsorptive media. Sorption is a general term that includes both adsorption and absorption. Similarly, a sorptive material or sorption device herein denoted as a sorber, refers to a material or device that both ad- and absorbs.

In certain embodiments, the filters comprise a nitrocellulose membrane structure which is preferably uniform and symmetric, supported on a suitable substrate such as a non-woven material. A suitable non-woven substrate is a polyester web. The porous components of the filter act as a supporting skeleton for the adsorptive hydrogel.

The polymer forms the adsorptive hydrogel and bears the chemical groups (binding groups) responsible for attracting and holding the impurities. Alternatively, the polymer possesses chemical groups that are easily modifiable to incorporate the binding groups. It is permeable to biomolecules so that proteins and other impurities can be captured into the depth of the filter, increasing adsorptive capacity. The preferred polymer is a polymeric primary amine. Examples of suitable polymeric primary amines include polyallylamine, polyvinylamine, polybutylamine, polylysine, their copolymers with one another and with other polymers, as well as their respective protonated forms. Polyallylamine (and/or its protonated form, for example polyallylamine hydrochloride (PAH)) has been found to be particularly useful. PAA is commercially available (Nitto Boseki) in a number of molecular weights, usually in the range from 1,000 to 150,000, and all these can be used for creating the filter. PAA and PAH are readily soluble in water. The pH of aqueous solution of PAA is about 10-12, while that of PAH is 3-5. PAA and PAH may be used interchangeably, however the pH of the final solution must be monitored and if necessary adjusted to the value above 10 so that non-protonated amino groups are available for reaction with a cross-linker.

The impregnated polymer typically constitutes at least about 3% of the total volume of the filter, preferably from about 5% to about 10%, of the total volume of the filter, but can be as high as about 50%.

A cross-linker reacts with the polymer to make the latter insoluble in water and thus held within the supporting skeleton. Suitable cross-linkers are difunctional or polyfunctional molecules that react with the polymer and are soluble in the chosen solvent, which is preferably water. A wide variety of chemical moieties react with primary amines, most notably epoxides, chloro-, bromo-, and iodoalkanes, carboxylic acid anhydrides and halides, aldehydes, α,β-unsaturated esters, nitriles, amides, and ketones. A preferred cross-linker is polyethylene glycol diglycidyl ether (PEG-DGE). It is readily soluble in water, provides fast and efficient cross-linking, and is hydrophilic, neutral, non-toxic and readily available. The amount of cross-linker used in the impregnating solution is based on the molar ratio of reactive groups on the polymer and on the cross-linker. The preferred ratio is in the range from about 10 to about 1,000, more preferred from about 20 to about 200, most preferred from about 30 to about 100. More cross-linker will hinder the ability of the hydrogel to swell and will thus reduce the sorptive capacity, while less cross-linker may result in incomplete cross-linking, i.e. leave some polymer molecules fully soluble.

A surfactant may be used to help spread the polymer solution uniformly within the supporting structure. Preferred surfactants are non-ionic, water-soluble, and alkaline stable. Fluorosurfactants possess a remarkable ability to lower water surface tension. These surfactants are sold under the trade name Zonyl by E.I. du Pont de Nemours and Company and are particularly suitable, such as Zonyl FSN and Zonyl FSH. Another acceptable class of surfactants are octylphenol ethoxylates, sold under the trade name Triton X by The Dow Chemical Company. Those skilled in the art will appreciate that other surfactants also may be used. The concentration of surfactant used in the solution is usually the minimum amount needed to lower the solution surface tension to avoid dewetting. Dewetting is defined as spontaneous beading up of liquid on the surface after initial spreading. The amount of surfactant needed can be conveniently determined by measuring contact angles that a drop of solution makes with a flat surface made from the same material as the porous skeleton. Dynamic advancing and receding contact angles are especially informative, which are measured as the liquid is added to or withdrawn from the drop of solution, respectively. Dewetting can be avoided if the solution is formulated to have the receding contact angle of 0°.

A small amount of a neutral hydrophilic polymer that readily adsorbs on a hydrophobic surface optionally may be added to the solution as a spreading aid. Polyvinyl alcohol is the preferred polymer and can be used in concentrations ranging from about 0.05 wt. % to about 5 wt. % of total solution volume.

When the supporting porous structure cannot be readily wetted with the solution of polymer, a wetting aid can be added to the solution. The wetting aid can be any organic solvent compatible with the coating polymer solution that does not negatively affect the cross-linking reaction. Typically the solvent is one of the lower aliphatic alcohols, but acetone, tetrahydrofuran, acetonitrile and other water-miscible solvents can be used as well. The amount of the added organic solvent is the minimum needed to effect instant wettability of the porous structure with the polymer solution. Exemplary wetting aids include methyl alcohol, ethyl alcohol, and isopropyl alcohol.

The above described surfactants, neutral hydrophilic polymers, and wetting aids are primarily needed when a hydrophobic porous structure is used for coating/impregnation. Conversely, very hydrophilic porous structures, such as cellulose-based filters, will not require addition of these components. In practice, it may preferable to avoid using surfactants or neutral hydrophilic polymers to minimize the cost and time needed for their extraction. Also, addition of alcohol wetting aid to coating/impregnation formulation may necessitate the use of explosion-proof equipment thus increasing the cost of the process.

A preferred process for forming the filter may comprise the steps of: 1) preparing the solution; 2) coating the filter material with the solution; 3) drying the filter; 4) curing the filter; 5) rinsing and drying of the filter; 6) optional annealing of the finished filter; and 7) optional acid treatment of the filter. More specifically, a solution is prepared that contains a suitable polymer and cross-linker. The concentrations of these two components determine the thickness and degree of swelling of the impregnated polymer, which in turn define flux through the filter and its sorptive capacity. The polymer and cross-linker are dissolved in a suitable solvent, preferably water. The solution may optionally contain other ingredients, such as wetting aids, spreading aids, and a pH adjuster. Finally, depending on the chemical nature of the cross-linker, the pH may need to be raised in order to effect the cross-linking reaction. Drying can be carried out by evaporation at room temperature or can be accelerated by applying heat (temperature range of about 30-110° C.). After the filter is dried, it can be held for a period of from several hours to several days so that cross-linker can fully react with the polymer. Cross-linking may be optionally accelerated by applying heat. The structure is subsequently rinsed with copious amounts of solvent and dried again. Additional optional process steps include annealing the structure at an elevated temperature (30-120° C.) to adjust its flow properties and treating it with a strong non-oxidizing monobasic acid at concentration 0.1M to 1M to protonate the amino groups present.

Where the polymer is PAA, converting essentially all amino groups in the polymer into corresponding ammonium salts after curing and/or heat treatment of the membrane will help ensure consistency of the product. A strong, non-toxic, non-oxidizing acid, preferably one that is monobasic to avoid ionic cross-linking of PAA, should be used to protonate PAA for this purpose. Suitable acids include hydrochloric, hydrobromic, sulfamic, methansulfonic, trichloroacetic, and trifluoroacetic acid. Although chloride may be the counter-ion of choice since it is already present in the sample protein solution, it may not be practical for a continuous process to use hydrochloric acid and/or its salt due to the corrosion of steel and the occupational safety issues involved. A more suitable acid is thus sulfamic acid (H₂N—SO₂OH) is preferred as the protonating agent for PAA.

A suitable process for protonating the PAA is to submerge the structure in a 0.1-0.5 M solution of the protonating acid, preferably sulfamic acid in water (or a water/alcohol mix to fully penetrate a poorly wetting structure), followed by rinsing and drying. The resulting filter will bear sulfamate counter-ions, which may be easily exchanged out by employing a simple conditioning protocol, such as 0.5M sodium hydroxide followed by 0.5M sodium chloride.

Such acid treatment improves shelf life stability of the filter, and also results in a significantly higher strength of binding. Although the present inventors should not be limited to any particular theory, it is believed that when PAA is dried in the fully protonated (acid-treated) state, it assumes a more extended, “open” morphology that is capable of better encapsulating BSA and HCP and thus will not release it until a higher ionic strength is reached. A further benefit of acid-treated filter is greater stability towards ionizing irradiation, such as gamma irradiation, which is an accepted sterilization procedure for filtration products.

Another important aspect is a post-treatment procedure employed after the filter is cured, rinsed, and dried. Treatment of the filter based on polymeric primary amines with acid significantly boosts its strength of binding, wettability, and stability towards ionizing radiation.

The permeability of the cross-linked PAA filter can be improved by a high-temperature “curing” process. The lightly cross-linked PAA-gel has the ability to absorb significant amount water resulting in orders of magnitude increase in its volume. This effect can cause low permeability. It appears that this property of the gel is reduced by dehydrating it to such an extent that it reduces the swelling to an acceptable level, without compromising the strength of binding and capacity of the gel. In fact, the curing process is capable of tuning the permeability as necessary for the product. Suitable curing temperatures are about 25-120° C., more preferably from about 85-100° C.; and for about 6 to 72 hours.

The following examples are included herein for the purpose of illustration and are not intended to limit the invention.

### Example 1

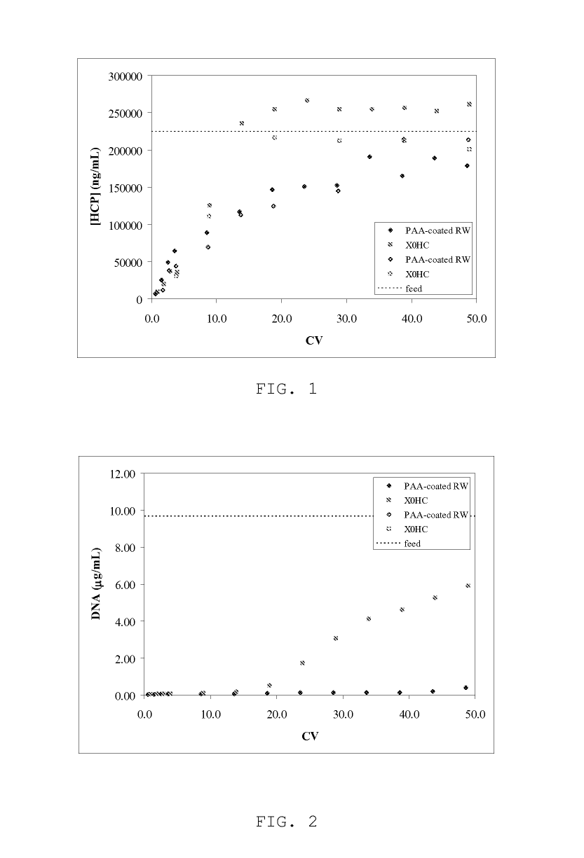

RW06 membrane commercially available from Millipore Corporation was coated with cross-linked polyallyamine solution with the composition as described in Table 1 below. The filters were air-dried and then extracted with Milli-Q water. Next, the filters were treated with 0.3 M sulfamic acid, washed with water, and redried. Six layers were incorporated into an approximately 25 mm diameter device. Non-expressing CHOs feed spiked with polyclonal human IgG was used to test the PAA-coated device. A typical value for feed pH at this is stage is around 7.5 and for conductivity is around 10.4 mS/cm. Millipore's XOHC range of Millistak+® media, which is comprised of cellulose fibers and diatomaceous earth held together with a polyamine binder, was also tested for comparison. The devices were loaded with the feed and fractions were collected for host cell protein (HCP) and DNA analysis. As seen in FIG. 1, the HCP removal of the PAA-coated RW device is better than that of the XOHC device. In FIG. 2, the PAA-coated RW device removes significantly more DNA as compared to the XOHC device.

TABLE 1
Coating solution composition

| chemical | grams |
|---|---|
| 15% polyallylamine (free base) in water | 120 |
| water | 280 |
| polyethylene glycol diglycidyl ether | 2.4 |

What is claimed is:

1. A method of removing impurities from a biological sample, comprising filtering said sample through porous sorptive media comprising mixed cellulose esters supported on a non-woven substrate and coated with a crosslinked polymer having attached primary amine groups.

2. The method of claim 1, wherein said biological sample comprises a solution having a pH of about 7.5.

3. The method of claim 1, wherein said biological sample comprises a solution having a conductivity of about 10.4 mS/cm.
